(19) United States
(12) Patent Application Publication
(10) Pub. No.: US 2009/0033731 A1
(43) Pub. Date: Feb. 5, 2009

(54) INKJET PRINTER

(75) Inventors: Akihito YAMAMOTO, Wakayama (JP); Yoshihisa HIGASHIMOTO, Wakayama (JP); Nobuaki NAKAOKA, Wakayama (JP)

Correspondence Address: Studebaker & Brackett PC, 1890 Preston White Drive, Suite 105, Reston, VA, 20191, US

(73) Assignee: Noritsu Koki Co., Ltd., Wakayama (JP)

(21) Appl. No.: 12/182,181

(22) Filed: Jul. 30, 2008

(30) Foreign Application Priority Data
Aug. 2, 2007 (JP) 2007-202172

(51) Int. Cl. B41J 2/01

(52) U.S. Cl. 347/102

(57) ABSTRACT

In an inkjet printer in which upstream and downstream output rollers engageable against their respective counter parts are disposed upstream and downstream, respectively, of a drying unit for drying printing paper after being printed, the upstream output roller is disengaged from its counter part after the disengagement between the downstream output roller and its counter part.

### CROSS-REFERENCE TO RELATED APPLICATION

This application claims priority under 35 USC 119 to Japanese Patent Application No. 2007-202172 filed on Aug. 2, 2007, the entire contents of which are incorporated herein by reference.

### BACKGROUND OF THE INVENTION

(a) Field of the Invention

This invention relates to inkjet printers.

(b) Description of the Related Art

Inkjet printers are conventionally known as devices for printing characters and images (hereinafter, characters and images are generically called “images”). The inkjet printers print images on paper by reciprocal movement in the paper width direction of their print heads ejecting ink.

In such an inkjet printer, if printed pieces of paper are stacked one after another on the paper output tray with ink on the pieces of paper not yet dried up, this causes inconveniences, such as a phenomenon that the ink on each piece of paper cannot uniformly be dried to cause color shading of the printed images or a phenomenon that ink adheres to the back sides of the stacked pieces of paper. Therefore, it is necessary to stack the printed pieces of paper on the paper output tray after the ink is well dried.

Published Japanese Patent Application No. 2001-270089 discloses a technique for an inkjet printer including: an infrared heater for drying ink landed on printed paper by heat energy; and an air nozzle for spraying air to the surface of the paper increased in temperature by the infrared heater to reduce the temperature of the paper. The inkjet printer further includes a heat-transfer blocking roller disposed upstream of the infrared heater in the direction of paper conveyance in order to avoid that heat energy produced by the infrared heater is transferred directly to the print head disposed upstream of the infrared heater in the direction of paper conveyance.

However, if the leading edge of the paper being printed by the print head abuts on the heat-transfer blocking roller engaged against a counter roller, vibrations caused by a shock of the abutment are transmitted through the paper to the print head side of the paper, which may cause problems, such as banding of images being printed.

In order to prevent such vibrations of paper, Published Japanese Patent Application No. 2001-83609 proposes a technique in which when the leading edge of paper reaches a pair of engaged conveyance rollers downstream of the print head, the pair of conveyance rollers are temporarily disengaged from each other to smoothly feed forward the leading edge of the paper through the gap between the pair of conveyance rollers.

### SUMMARY OF THE INVENTION

The technique disclosed in Published Japanese Patent Application No. 2001-83609 is a technique of disengaging all of pairs of engaged conveyance rollers downstream of the print bead. Therefore, if this technique is directly applied to inkjet printers including a drying device for drying printed paper, heat energy produced by the drying device is transmitted from the gap between each pair of disengaged conveyance rollers to the upstream side in the direction of paper conveyance, which may have adverse effects on units having poor heat resistance.

The present invention has been made in view of the foregoing points and, therefore, an object thereof is to provide an inkjet printer that prevents the leading edge of paper being printed by the print head from abutting on rollers downstream of the print head and thereby causing vibrations while restraining heat energy from being transmitted upstream of a drying device for drying the paper.

To attain the above object, in the present invention, the disengagement between an upstream roller disposed upstream of the drying device and its counter part engaged against the upstream roller is carried out after the disengagement between a downstream roller disposed downstream of the drying device and a counter part engaged against the downstream roller.

Specifically, the present invention is directed to an inkjet printer for printing an image on paper by ejecting ink from a print head to the paper and takes the following solutions.

In a first aspect of the invention, the inkjet printer includes: a drying device for drying the paper after an image is printed thereon; an upstream roller disposed upstream of the drying device in a direction of paper conveyance and engageable against a counter part thereof; a downstream roller disposed downstream of the drying device in the direction of paper conveyance and engageable against a counter part thereof; and an engagement/disengagement switching device for engaging and disengaging the upstream roller and its counter part against and from each other and engaging and disengaging the downstream roller and its counter part against and from each other, the engagement/disengagement switching device being configured to disengage the upstream roller and its counter part from each other after disengaging the downstream roller and its counter part from each other.

Since, thus, the upstream roller is disengaged from its counter part after the disengagement between the downstream roller and its counter part, heat energy produced by the drying device and having resided in a drying chamber defined by the upstream and downstream rollers is released to the outside through the gap created between the downstream roller and its counter part upon disengagement between them. When the upstream roller is disengaged from its counter part later, the heat energy residing in the drying chamber has already been reduced, which is advantageous in restraining the heat energy from being transmitted upstream through the gap between the upstream roller and its counter part. This restrains heat energy from being transmitted upstream of the drying device while preventing that the leading edge of the paper being printed by the print head abuts on the upstream roller to cause vibrations.

A second aspect of the invention is the inkjet printer according to the first aspect of the invention, wherein the drying device is configured to dry the printed paper by blowing dry air against the printed paper and downstream in the direction of paper conveyance.

Since in the above manner the drying device blows dry air against the printed paper and downstream in the direction of paper conveyance, upon disengagement between the downstream roller and its counter part, the dry air is more positively blown to the outside through the gap between the downstream roller and its counter part. Thus, the amount of dry air residing in a drying chamber defined by the upstream and downstream rollers is reduced, which restrains the amount of dry air flowing upstream through the gap created between the upstream roller and its counter part upon disengagement between them.

As described so far, since according to the inkjet printer of the present invention the upstream roller is disengaged from its counter part after the disengagement between the downstream roller and its counter part, this restrains heat energy from being transmitted upstream of the drying device while preventing that the leading edge of the paper being printed by the print head abuts on the upstream roller to cause vibrations.

### BRIEF DESCRIPTION OF THE DRAWINGS

FIG. 1 is a perspective view showing the appearance of an inkjet printer according to an embodiment of the present invention and serving as an image forming apparatus.

FIG. 2 is a perspective view showing the structure of the inkjet printer inside a housing.

FIG. 3 is a plan view showing the structure of the inkjet printer inside the housing.

FIG. 4 is a front view showing the structure of the inkjet printer inside the housing.

FIG. 5 is a left side view showing the structure of the inkjet printer inside the housing.

FIG. 6 is a rear view showing the structure of the inkjet printer inside the housing.

FIG. 7 is a schematic diagram of the inkjet printer when viewed from the left of the housing, showing a conveyance path of printing paper.

FIG. 8 is a cross-sectional view showing the structure of a drying unit when viewed from the left of the housing.

FIG. 9 is a plan view showing the structures of output rollers.

FIG. 10 is a side view showing a state that all of a pair of conveyance rollers, a pair of upstream rollers and a pair of downstream rollers are engaged, as viewed from the right of the housing.

FIG. 11 is a side view showing a state that the pair of conveyance rollers and the pair of downstream output rollers are disengaged, as viewed from the right of the housing.

FIG. 12 is a side view showing a state that all of the pair of conveyance rollers, the pair of upstream rollers and the pair of downstream rollers are disengaged, as viewed from the right of the housing.

### DETAILED DESCRIPTION OF THE INVENTION

A description is given below of an embodiment of the present invention with reference to the drawings. The following preferred embodiment is merely illustrative in nature and is not intended to limit the scope, applications and use of the invention.

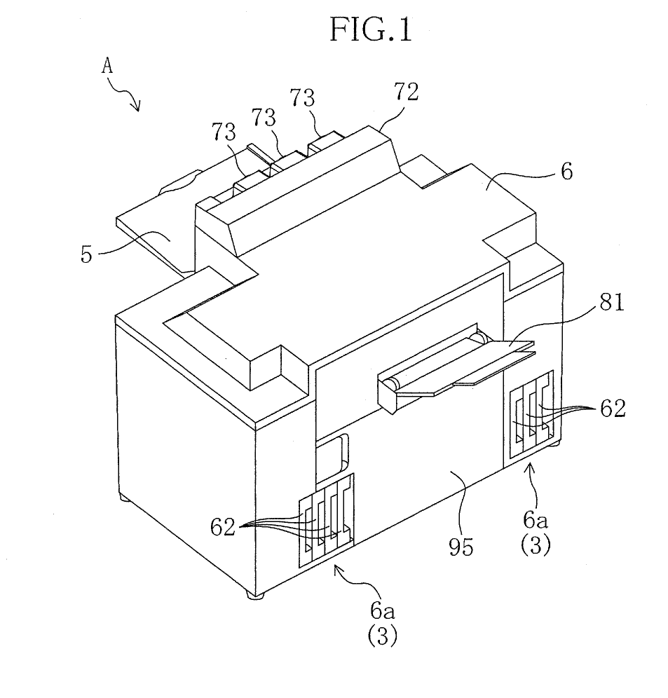

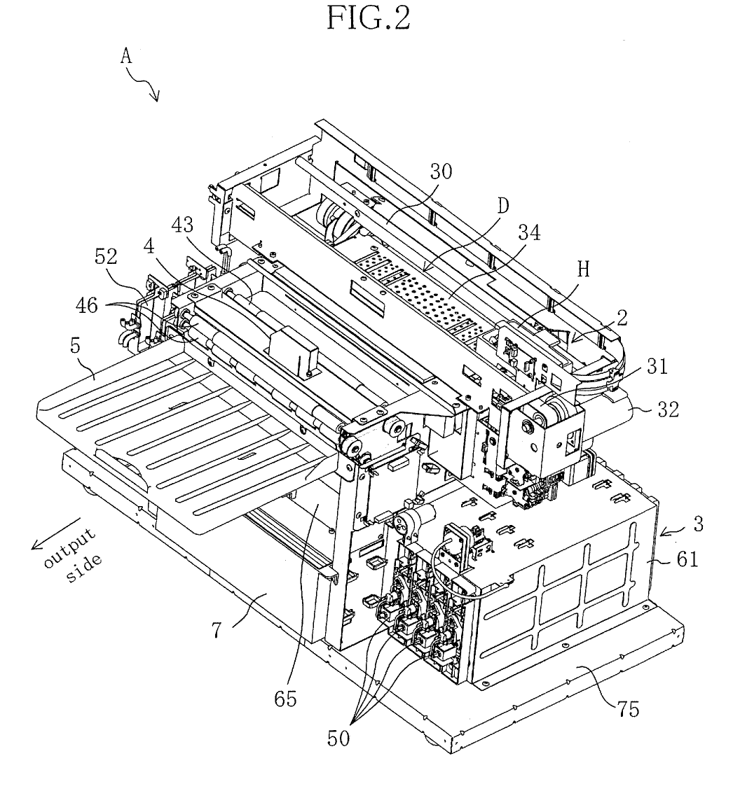

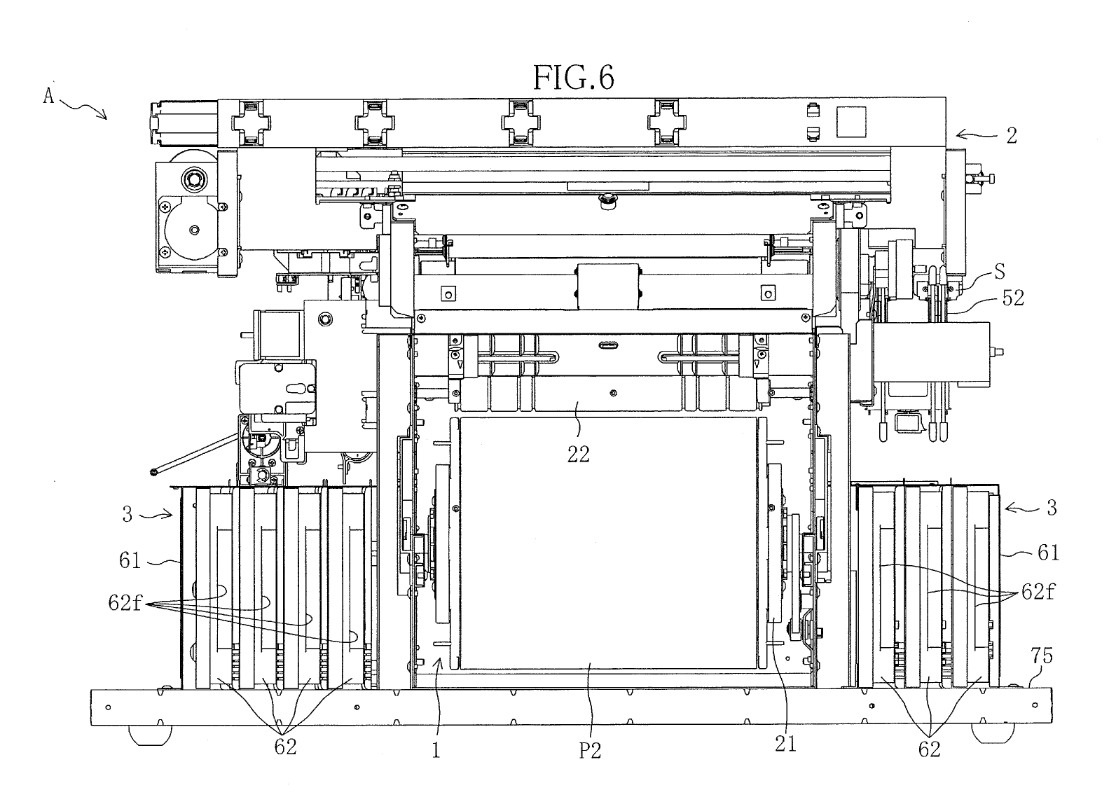

FIG. 1 shows the appearance of an inkjet printer A according to an embodiment of the present invention and FIGS. 2 to 7 show the internal structure of the inkjet printer A. The inkjet printer A is used for a photographic printing system and, for example, used for printing photographic images on printing paper P1 or P2 based on image data transmitted via a communication cable from a reception block for obtaining the image data and correcting it as necessary. More specifically, the inkjet printer A is configured to be capable of performing an automatic printing for pulling out one end of a long roll of printing paper P2 and printing an image on the printing surface of the roll of printing paper P2 (hereinafter, referred to as a paper web P2) and a manual-feed printing for printing an image on the printing surface of a sheet of printing paper P1 (hereinafter, referred to as a paper sheet P1) previously cut in a given size.

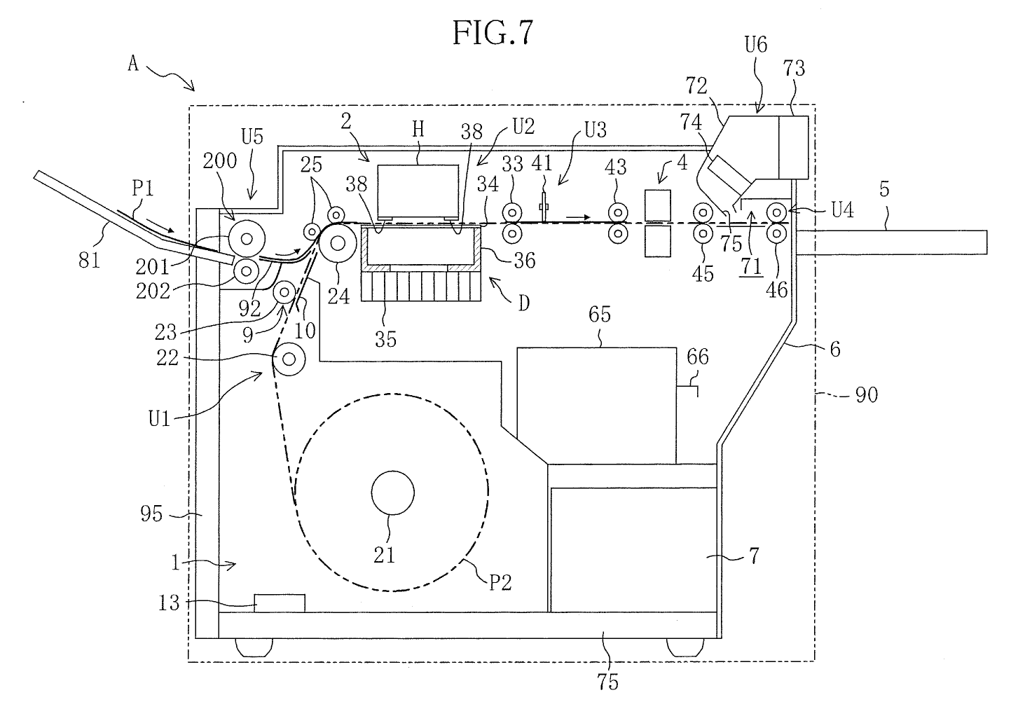

Note that when in the following description the paper web P2 and the paper sheet P1 need not be particularly distinguished, they are referred to as printing paper P1 or P2. Furthermore, the printing surface means the surface on which an image is to be printed. The printing surface of each paper sheet P1 is determined when the paper sheet P1 is set on a manual-feed tray 81 (see FIG. 7). Specifically, the printing surface is the side of the paper sheet P1 facing upward when the paper sheet P1 is set on the manual-feed tray 81. On the other hand, the printing surface of the paper web P2 is the side thereof facing radially outward when the paper web P2 is rolled.

### —General Structure—

As shown in FIG. 7, the inkjet printer A includes a printer body 90 and a manual-feed tray 81 for manually setting a paper sheet P1 thereon and feeding it therefrom into the printer body 90. The printer body 90 includes: a housing 6; a paper roll containing part 1 (containing room) disposed in a lower part of the interior of the housing 6 and containing a paper web P2 rolled with its printing surface outside; a printing part 2 (see FIGS. 2 and 7), disposed in an upper part of the interior of the housing 6 (above the paper roll containing part 1), for printing based on image data an image on the printing surface of the paper sheet P1 fed from the manual-feed tray 81 or the printing surface of the paper web P2 pulled out of the paper roll containing part 1; ink storages 3, located in the lower part of the interior of the housing 6 on both sides of the paper roll containing part 1, for storing ink to be supplied to the printing part 2; and a roller unit 200, disposed on an upper part of a cover member 95 attached to the housing 6 to be freely opened and closed, for conveying and feeding a paper sheet P1 set on the manual-feed tray 81 towards the printing part 2 when the cover member 95 is closed.

Disposed in the upper part of the housing 6 and downstream of the printing part 2 in the direction of paper conveyance are a roller cutter 41 for cutting out an unnecessary part of printed printing paper P1 or P2, a back printing unit 4 for printing a serial number on the back side of each piece of printing paper P1 or P2, a drying unit U6 for drying the piece of printing paper P1 or P2 printed in the printing part 2, and a pair of upstream output rollers 45 vertically arranged and engaged against each other and a pair of downstream output rollers 46 vertically arranged and engaged against each other, both pairs for conveying the piece of printing paper P1 or P2 printed in the printing part 2 further downstream and outputting it. Disposed downstream of the pair of downstream output rollers 46 in the direction of paper conveyance is a paper output tray 5, extending outside from an output port 47 in the housing 6, for receiving the piece of printing paper P1 or P2 delivered by the pair of downstream output rollers 46.

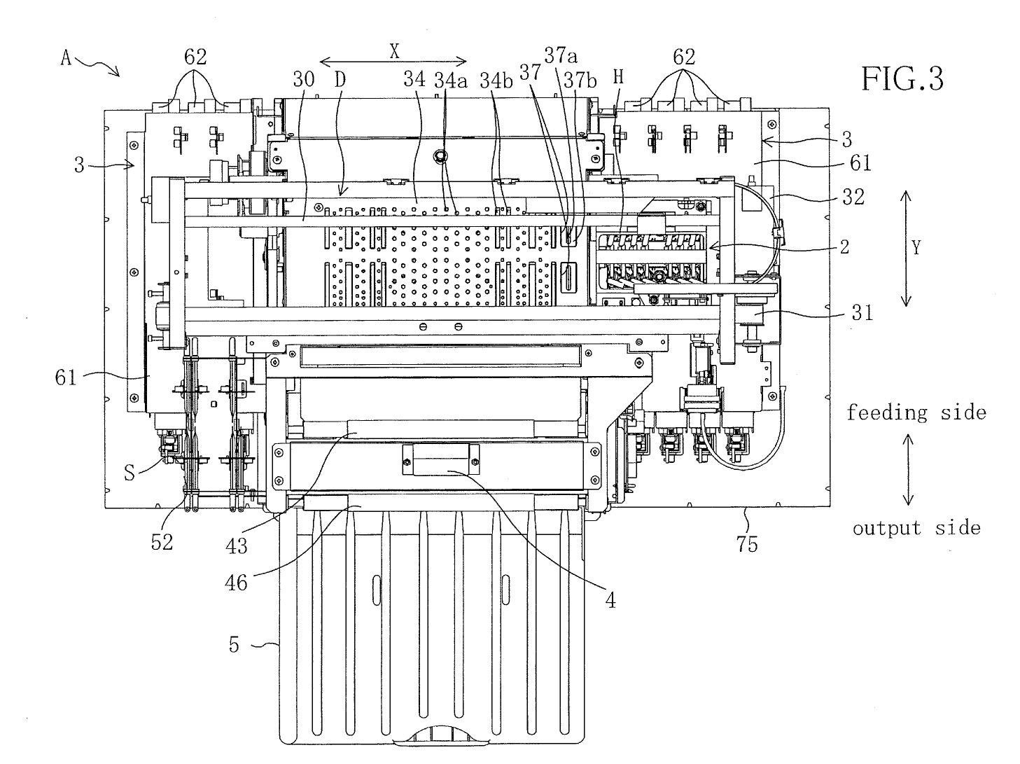

In this embodiment, the side of the housing 6 towards the paper output tray 5 (“output side” shown in FIG. 3) is referred to as the housing front side, the side thereof opposite to the paper output tray 5 (“feeding side” shown in FIG. 3) is referred to as the housing rear side, the left side thereof as viewed from the housing front side is referred to as the housing left side, and the right side thereof as viewed from the housing front side is referred to as the housing right side. Therefore, the right-to-left direction in FIG. 7 is the housing front-to-rear direction and the direction orthogonal to the drawing sheet of FIG. 7 is the housing right-to-left direction. The housing right-to-left direction coincides with the width direction of the paper sheet P1 set on and fed from the manual-feed tray 81 and the width direction of the paper web P2 contained in and fed from the paper roll containing part 1.

The printing part 2 includes a print head H (see FIGS. 2 to 4 and FIG. 7) for ejecting ink therefrom to the printing paper P1 or P2 and forming an image on it. The print head H is configured to be movable along a rail 30 extending in a main scanning direction X (see FIG. 3) coinciding with the width direction of the printing paper P1 or P2 (i.e., the housing right-to-left direction). Specifically, when the rotational force of a drive motor 32 is transmitted through a pulley to a drive belt 31, the print head H moves in the main scanning direction X according to the amount of rotation of the drive belt 31.

The print head H further includes two head units 38 and 38 (see FIG. 7) arranged along a sub-scanning direction Y (see FIG. 3) orthogonal to the main scanning direction X and coinciding with the direction of travel of the printing paper P1 or P2 (i.e., the housing front-to-rear direction). The print head H is configured to print a given image or characters on the printing paper P1 or P2 by ejecting ink through ink-jet nozzles (not shown) formed in these two head units 38 and 38.

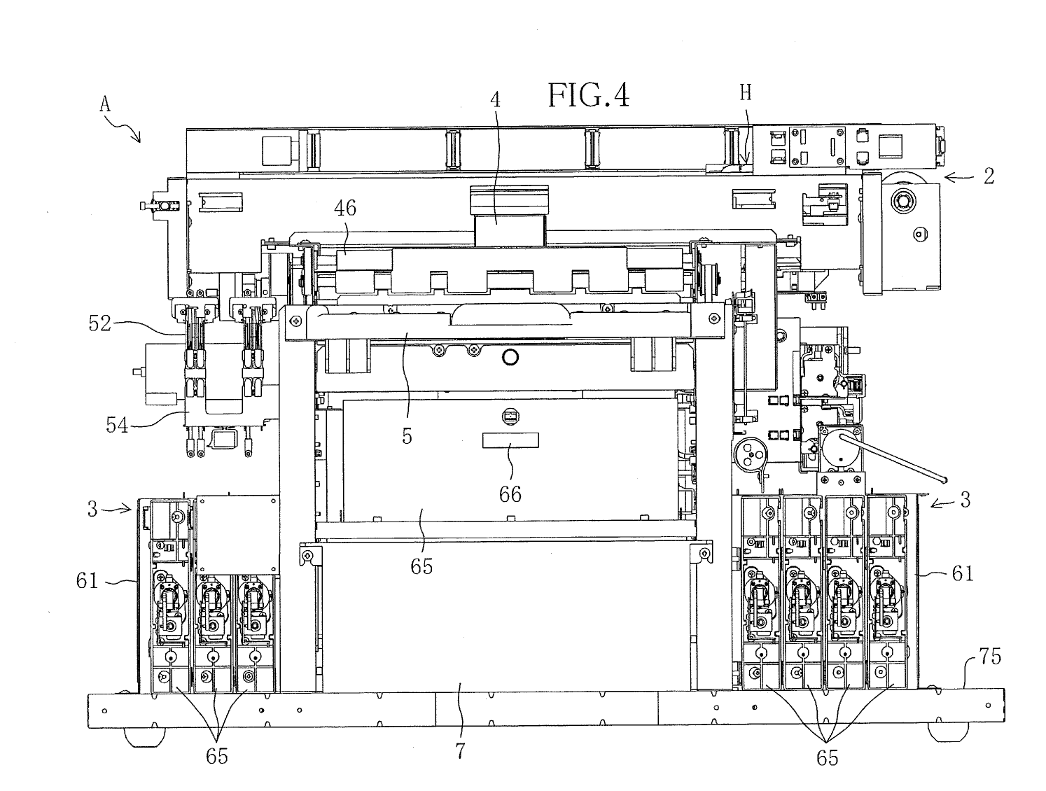

The ink storages 3 include their respective box-shaped cases 61 (see FIG. 4) disposed on the right and left of the inkjet printer A. These cases 61 contain seven removable ink cartridges in total (in FIG. 4, three in the left case 61 and four in the right case 61). The ink cartridges 62 are charged with different types of ink having different hues. Therefore, the ink cartridges 62 spent or being used can be replaced with new ones by removing them from the cases 61 and setting new ones in the cases 61. Seven types of ink charged in these ink cartridges 62 are yellow (Y), magenta (M), cyan (C), black (K), red (R), violet (V) and clear (CL).

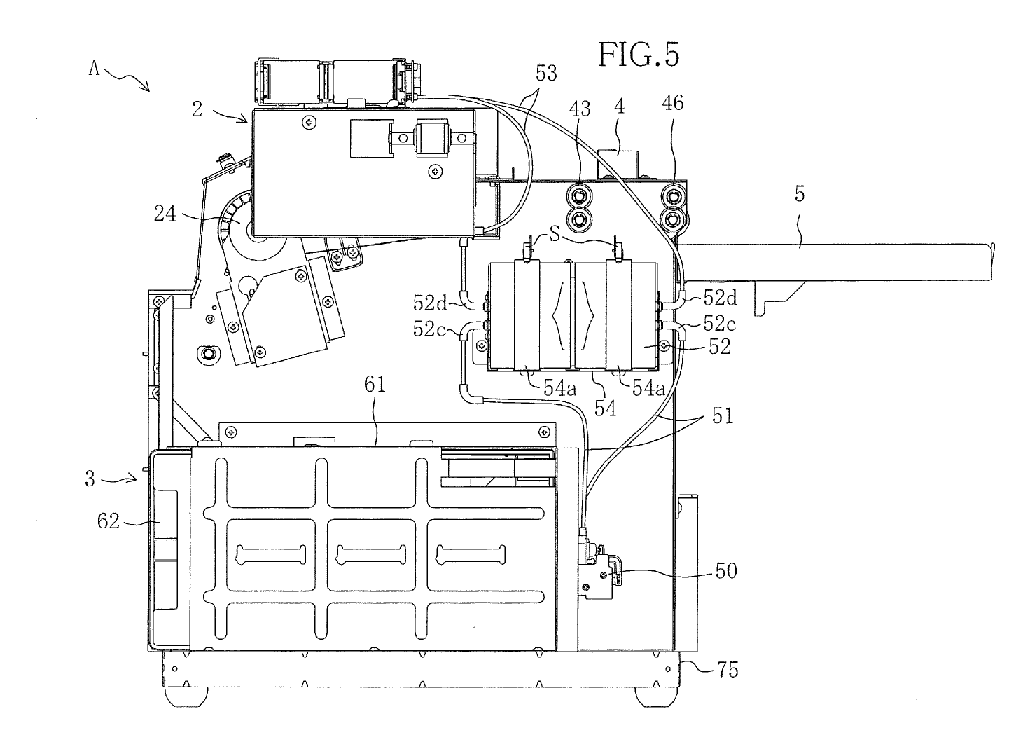

Furthermore, sub-tanks 52 (see FIGS. 4 and 5) for temporarily storing ink supplied from the ink cartridges 62 are disposed to the left as viewed from the output side of the inkjet printer A and at a height between the ink storages 3 and the printing part 2. These sub-tanks 52 are connected to the print head H of the printing part 2 and configured to supply different types of ink therein to the print head H by negative pressure produced in ejecting the these types of ink through the associated nozzles of the print head H.

### —Paper Conveyance Mechanism—

As shown in FIG. 7, the inkjet printer A is provided with a paper conveyance mechanism for pulling in a paper sheet P1 from the manual-feed tray 81 and conveying it along a given conveyance path. To form the conveyance path, the paper conveyance mechanism includes, in order from the manual-feed tray 81, a manual-feed unit U5, a printing unit U2, a cutter unit U3, the drying unit U6 and a paper output unit U4. Thus, image data is printed on the printing surface of the printing paper P1 or P2 located on the conveyance path in the printing unit U2 provided in the printing part 2. In this embodiment, for another paper feed path other than the feed path of a paper sheet P1 from the manual-feed tray 81 to the printing unit U2, the paper conveyance mechanism further includes a feed unit U1 configured to pull the leading edge of a paper web P2 out of the paper roll containing part 1 and feed it to the printing part 2.

In printing on a paper sheet P1, the paper conveyance mechanism is configured so that the manual-feed unit U5 feeds the paper sheet P1 set on the manual-feed tray 81 to the printing unit U2, the printing unit U2 then prints image data on the fed paper sheet P1 with the print head H while conveying the paper sheet P1 towards the cutter unit U3, the cutter unit U3 then cuts the printed paper sheet P1 in a given print size, the drying unit U6 then dries the paper sheet P1 and the paper output unit U4 conveys the paper sheet P1 out to the paper output tray 5. Hereinafter, the upstream side and downstream side in the direction of conveyance of the paper sheet P1 being conveyed during printing is referred to simply as the upstream side and downstream side, respectively.

The manual-feed unit U5 includes the roller unit 200 for guiding the paper sheet P1 to the printing part 2. The roller unit 200 includes a drive roller 202 and a driven roller 201. The manual-feed unit U5 guides the paper sheet P1 from the manual-feed tray 81 into the printer body 90 by driving the drive roller 202 into rotation.

The feed unit U1 includes a core roller 21 for winding a paper web P2 in a roll thereon to contain the rolled paper web P2 in the paper roll containing part 1, a transverse restriction roller 22 for restricting the transverse position of the paper web P2 pulled out of the core roller 21, a closing roller 23 described later, a conveyance drive roller 24 capable of being driven into rotation by an unshown electric motor to convey the paper web P2, and two pinch rollers 25 opposed to the conveyance drive roller 24 and engageable against the conveyance drive roller 24 to pinch the paper web P2 together with the conveyance drive roller 24.

The feed unit U1 is configured to pull the paper web P2 out of the paper roll containing part 1 and also feed it to the printing part 2 by the rotation of the conveyance drive roller 24. Although in this embodiment the feed unit U1 includes the transverse restriction roller 22, it may include a guide for restricting the transverse position of the paper web P2 instead.

The closing roller 23 is provided to ensure the airtightness of the paper roll containing part 1 and thereby prevent the interior of the paper roll containing part 1 from falling into a low-humidity condition. Specifically, the walls defining the paper roll containing part 1 need to have a paper lead-out opening 9 for leading the paper web P2 out of the paper roll containing part 1 to the other space of the interior of the housing 6 (i.e., the space thereof containing the printing part 2). If the paper lead-out opening 9 remains open, the airtightness of the paper roll containing part 1 cannot be ensured. Therefore, the paper lead-out opening 9 is provided with the closing roller 23 that closes the paper lead-out opening 9 to allow the paper web P2 to pass through it.

At least the outer peripheral part of the closing roller 23 is made of an elastically deformable material, such as foam including sponge or rubber. The closing roller 23 is configured to contact the paper web P2 passing through the paper lead-out opening 9 while elastically deforming radially inwardly and be thereby driven into rotation. During the contact, the paper web P2 is pressed against a guide member 10 disposed opposite to the closing roller 23 (but its pressing force is substantially small). Thus, the paper web P2 can pass through the paper lead-out opening 9 with little resistance from the closing roller 23 while the paper roll containing part 1 can keep its airtightness.

The closing roller 23 may be configured to act as a drive roller for positively feeding the paper web P2 in the direction of paper conveyance or rewinding the paper web P2. The rotation of the closing roller 23 can be implemented without any electric motor intended for the closing roller 23 by transmitting the rotational driving force of the conveyance drive roller 24 to the closing roller 23, such as by an unshown solenoid clutch, which is advantageous in space saving and cost reduction of the inkjet printer A.

When the paper web P2 is not in the paper lead-out opening 9, the closing roller 23 is in contact with the guide member 10. Also in this case, the airtightness of the paper roll containing part 1 can be ensured. In the paper roll containing part 1 thus keeping airtightness, a container 13 containing water and opening at its top is disposed. The water in the container 13 liquefies into vapor, whereby the interior of the paper roll containing part 1 is efficiently humidified.

Thus, even if the inkjet printer A itself is put under low-humidity conditions for a long time, the interior of the paper roll containing part 1 can be kept at an appropriate humidity (where printing paper can be used within the relative humidity range of 30% to 75%, preferably 40% to 60%), which prevents the paper web P2 from producing such a curl that the widthwise middle of the paper web P2 rises on the printing surface side with respect to both widthwise ends thereof.

The conveyance drive roller 24 is configured to be rotated forward by an unshown electric motor to pull the paper web P2 out of the paper roll containing part 1 and feed it to the printing part 2 and rotated backward by the electric motor to return the paper web P2 to the paper roll containing part 1.

Thus, the inkjet printer A can cut off the printed part of the paper web P2 into a given size by the cutter unit U3 downstream of the printing part 2, then return the remaining long paper web P2 after the cutting upstream and restart printing with the leading edge of the remaining paper web P2 or can return the long paper web P2 after the cutting into the paper roll containing part 1, feed a cut paper sheet P1 to the printing part 2 through the manual-feed unit U5 and print on it. Furthermore, in replacing the long paper web P2 with new one, the long paper web P2 pulled out of the paper roll containing part 1 can be returned into the paper roll containing part 1.

The printing unit U2 includes: a paper holder D (see FIGS. 3 and 7) for holding by suction the printing paper P1 or P2 at a position allowing printing of the print head H; and a pair of paper conveyance rollers 33 disposed downstream of the paper holder D and engaged against each other. The conveyance drive roller 24 and the pinch rollers 25 in the feed unit U1 are used also as components of the printing unit U2 and act to convey the printing paper P1 or P2 in the printing unit U2.

The paper holder D includes: a platen 34 having suction holes 34a (see FIG. 3) opening at the surface (top); and a fan 35 (see FIG. 7) as a suction device for sucking the printing paper P1 or P2, which is fed onto the platen 34 by the feed unit U1, through the suction holes 34a and thereby holding it on the surface of the platen 34. The platen 34 is composed of a plate material. Disposed on the back (bottom) of the platen 34 is a case 36 forming a space together with the platen 34. The fan 35 is disposed under the case 36. The suction holes 34a pass through the platen 34 in the thickness direction and are communicated with the space in the case 36. The space in the case 36 is communicated through an opening formed in the bottom of the case 36 with the inlet opening of the fan 35. When the fan 35 is operated, negative pressure is produced through the suction holes 34a on the surface of the platen 34, whereby the printing paper P1 or P2 is held on the surface of the platen 34 by suction.

The platen 34 further includes: flashing parts 37 (see FIG. 3) for receiving a small amount of ink ejected through the inkjet nozzles in the head units 38 of the print head H to prevent the ink viscosity from increasing in printing; and caps (not shown) disposed at a standby position of the print head H during deactivation of the inkjet printer A and configured to cover the ink-jet nozzles in the head units 38 of the print head H to prevent the ink viscosity from increasing.

Each flashing part 37 includes an opening 37a (see FIG. 3) formed in the platen 34. Disposed below the flashing part 37a in the platen 34 is a case (not shown) forming a space communicated with the opening 37a. The case is communicated with a waste tank 7 (see FIGS. 2 and 7) disposed in the lower part of the housing 6 towards the housing front side. Furthermore, an ink absorbing material 37b made of sponge capable of absorbing ink is disposed in the opening 37a. The ink infiltrating the ink absorbing material 37b accumulates in the space in the case located below the associated flashing part 37. Thus, the ink ejected towards the openings 37a of the flashing parts 37 is led into the waste tank 7 after accumulating in the spaces in the cases.

Each cap is, although not particularly shown in the figures, configured to have a space put under negative pressure to draw a slight amount of ink through the ink-jet nozzles into the space when it covers the bottom surface of the print head H. Thus, it can be prevented that the ink in the ink-jet nozzles increases the viscosity to become difficult to eject.

The print head H includes two head units 38 having a plurality of ink-jet nozzles and disposed in two stages in the sub-scanning direction Y on the bottom thereof (the surface opposed to the platen 34), as described previously. However, the number of head units 38 may not necessarily be two and may be one or may be three or more.

Both the head units 38 have the same structure and each of them is composed of seven nozzle arrays, arranged in the main scanning direction X, for ejecting different types of ink of different colors therefrom. In each nozzle array, ink-jet nozzles as described above are aligned in the sub-scanning direction Y. Thus, each head unit 38 can make color images independently of the other. The printing paper P1 or P2 is intermittently (stepwise) conveyed in certain unit amounts of conveyance in the sub-scanning direction Y by the conveyance drive roller 24. During each stopping time of the printing paper P1 or P2 in the course of intermittent conveyance, the print head H scans one way (makes a forward scanning or a backward scanning) in the main scanning direction X. During the scanning, seven different types of ink of different colors are concurrently ejected through the associated ink-jet nozzles of each head unit 38 to the printing surface of the printing paper P1 or P2. In other words, after a single scanning of the print head H, the printing paper P1 or P2 is conveyed by a unit amount of conveyance and the print head H then scans once. By repeating this operation, a desired image is printed. In this embodiment, in order to eject ink from the print head H, common piezoelectric technology is employed in which the volume of a pressure chamber charged with ink is changed by a piezoelectric element and ink is thereby ejected through the inkjet nozzles communicated with the pressure chamber.

The cutter unit U3 includes a roller cutter 41 and is configured to cut the printing paper P1 or P2 into a given size (length) by moving the roller cutter 41 in the width direction at an appropriate position of the length of the printing paper P1 or P2 while rotating the roller cutter 41. Disposed below the roller cutter 41 is a chip collecting box 65 for collecting chips of the printing paper P1 or P2 formed by the cutting. The chip collecting box 65 is configured so that the operator can slide it out of the housing 6 by pulling its handle 66 and take out the chips collected in it. The housing front side of the chip collecting box 65 is made of clear plastic material to allow visual check for collection of chips.

Furthermore, the cutter unit U3 is configured to convey the printing paper P1 or P2 to the paper output unit U4 by means of a pair of conveyance rollers 43 vertically arranged and engaged against each other. The back printing unit 4 is disposed between the cutter unit U3 and the paper output unit U4. In the back printing unit 4, a serial number or the like is printed on the back (underside) of the printing paper P1 or P2 passing through it.

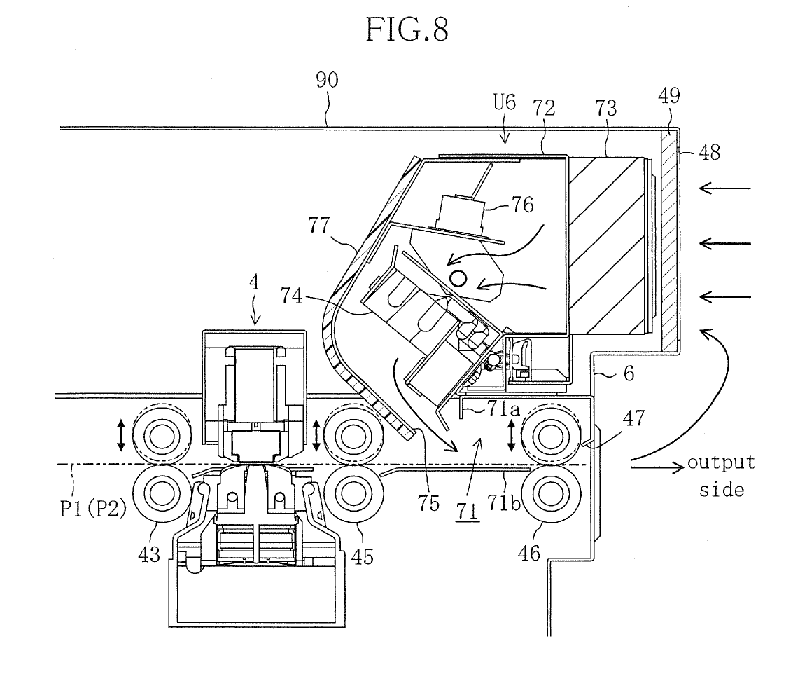

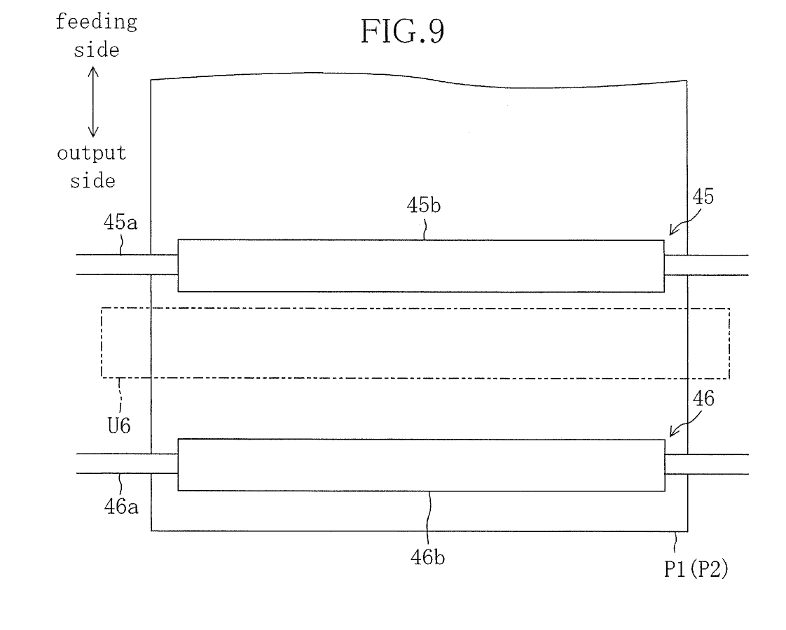

A description is given below of the behaviors of the pair of upstream output rollers 45 and the pair of downstream output rollers 46 and the structure of the drying unit U6, which are features of the present invention, with reference to FIGS. 8 to 12. The paper output unit U4 includes the pair of upstream output rollers 45 engaged against each other and the pair of downstream output rollers 46 engaged against each other. These output rollers 45 and 46 are configured to convey the printing paper P1 or P2 and deliver it to the paper output tray 5.

Each of the pair of upstream output rollers 45 is composed of a roller shaft 45a extending in the width direction of the printing paper P1 or P2 and a roller body 45b disposed concentrically around the roller shaft 45a and having a length corresponding to the width of the printing paper P1 or P2. Likewise, each of the pair of downstream output rollers 46 is composed of a roller shaft 46a extending in the width direction of the printing paper P1 or P2 and a roller body 46b disposed concentrically around the roller shaft 46a and having a length corresponding to the width of the printing paper P1 or P2.

The switching between engagement and disengagement of the pair of upstream output rollers 45 and the switching between engagement and disengagement of the pair of downstream output rollers 46 are carried out by cams 86 and 87 and cam followers 56a and 57a, all of which are described later and constitute an engagement/disengagement switching device.

Disposed between two pairs of engageable rollers in the paper output unit U4, i.e., between the pair of upstream output rollers 45 and the pair of downstream output rollers 46, is the drying unit U6 for drying the printing paper P1 or P2 by blowing dry air against the printing paper P1 or P2. The drying unit U6 sucks air into the housing 6 through an air inlet 48 formed in the housing 6 above and in the vicinity of the output port 47, applies heat to the sucked air and blows out the air as dry air. The air inlet 48 is provided with a dust collection filter 49 to prevent dusts in the air from being sucked into the drying unit U6.

The drying unit U6 includes, as shown in FIG. 8, a drying chamber 71 disposed on the conveyance path of the printing paper P1 or P2 and a dryer 72 (drying device) for supplying dry air to the drying chamber 71. The drying chamber 71 is defined by an upper partition wall 71a and a lower partition wall 71b that are opposed to each other with the printing paper P1 or P2 therebetween, and constitutes a retention space for retaining dry air blown against the printing paper P1 or P2 from the dryer 72.

The dryer 72 includes a plurality of intake fans 73 disposed in the housing 6 at laterally spaced intervals to take air from the outside through the air inlet 48 in the housing 6 into the dryer 72, a heater 74 for heating the air taken in by the intake fans 73, an exhaust nozzle 75, disposed at the lower end of the dryer 72 and opening downstream in the direction of paper conveyance, for blowing dry air heated by the heater 74 therethrough downstream in the direction of paper conveyance, and a safety thermostat 76 for detecting the internal temperature of the dryer 72 and stopping the heater 74 in time of necessity. A heat insulating material 77 is attached to an upstream portion of the body outer wall of the dryer 72 in the direction of paper conveyance, also including the exhaust nozzle 75. The provision of such a heat insulating material 77 restrains heat radiated by the dryer 72 from being transmitted to the units disposed upstream of the dryer 72 in the direction of paper conveyance and weak against heat, such as the back printing unit 4 using an ink ribbon.

The drying unit U6 is configured to blow dry air against the printed printing paper P1 or P2 and downstream in the direction of paper conveyance. By the above configuration, the period of time when dry air blows against the printing paper P1 or P2 can be extended. If dry air is blown vertically against the printing paper P1 or P2, it hits directly only on the surface of the printing paper P1 or P2 opposed to the outlet of the exhaust nozzle 75 of the dryer 72. On the other hand, when dry air is blown downstream in the direction of paper conveyance, it can hit directly not only on the target printing paper P1 or P2 but also on the printing paper P1 or P2 traveling downstream in the direction of paper conveyance, which provides an extended drying time for each printing paper P1 or P2 and efficient drying. This is advantageous in preventing inconveniences caused when printed pieces of printing paper P1 or P2 are stacked one after another on the paper output tray 5, such as a phenomenon that ink on each printed piece of paper is not uniformly dried to cause color shading of printed images.

When the pair of downstream output rollers 46 are disengaged from each other, dry air is more positively blown through the gap between the pair of disengaged downstream output rollers 46 out to the outside. Thus, the amount of dry air residing in the drying chamber 71 is reduced, which restrains the amount of dry air flowing upstream through the gap created between the pair of upstream output rollers 45 upon disengagement between them.

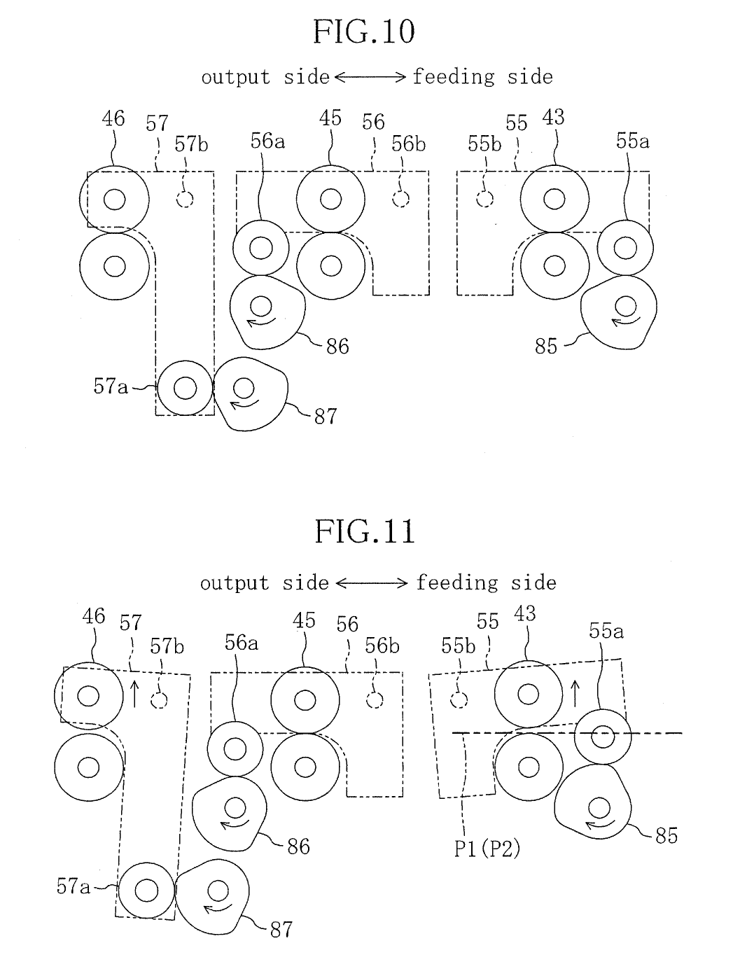

Next, a description is given of the behaviors of the pair of upstream output rollers 45 and the pair of downstream output rollers 46. FIG. 10 shows a state that all of the pair of conveyance rollers 43, the pair of upstream output rollers 45 and the pair of downstream output rollers 46 are engaged or closed. The upper one of the pair of conveyance rollers 43 is attached to substantially the middle of a roller bracket 55 in the direction of paper conveyance. The roller bracket 55 has a cam follower 55a provided at the upstream end and lower end thereof and a pivot shaft 55b provided downstream of the pair of conveyance rollers 43. The roller bracket 55 is configured to pivotally move about the pivot shaft 55b. Disposed under the cam follower 55a is a cam 85. The cam surface of the cam 85 bears against the outer periphery of the cam follower 55a. The upper one of the pair of conveyance rollers 43 is configured to be switched between its engaged position and disengaged position relative to the lower one serving as a counter part by clockwise rotation of the cam 85 when viewed in FIG. 10. The roller bracket 55 is urged towards clockwise rotating the upper conveyance roller 43 when viewed in FIG. 10.

The upper one of the pair of upstream output rollers 45 constituting an upstream roller is attached to substantially the middle of a roller bracket 56 in the direction of paper conveyance. The roller bracket 56 has a cam follower 56a provided at the downstream end and lower end thereof and a pivot shaft 56b provided upstream of the pair of upstream output rollers 45. The roller bracket 56 is configured to pivotally move about the pivot shaft 56b. Disposed under the cam follower 56a is a cam 86. The cam surface of the cam 86 bears against the outer periphery of the cam follower 56a. The upper one of the pair of upstream output rollers 45 is configured to be switched between its engaged position and disengaged position relative to the lower one constituting a counter part by clockwise rotation of the cam 86 when viewed in FIG. 10. The roller bracket 56 is urged towards counterclockwise rotating the upper upstream output roller 45 when viewed in FIG. 10.

The upper one of the pair of downstream output rollers 46 constituting a downstream roller is attached to the downstream end and upper end of a roller bracket 57. The roller bracket 57 has a cam follower 57a provided at the upstream end and lower end thereof and a pivot shaft 57b provided at the upstream end and upper end thereof. The roller bracket 57 is configured to pivotally move about the pivot shaft 57b. Disposed on the upstream side of the cam follower 57a is a cam 87. The cam surface of the cam 87 bears against the outer periphery of the cam follower 57a. The upper one of the pair of downstream output rollers 46 is configured to be switched between its engaged position and disengaged position relative to the lower one constituting a counter part by clockwise rotation of the cam 87 when viewed in FIG. 10. The roller bracket 57 is urged towards counterclockwise rotating the upper downstream output roller 46 when viewed in FIG. 10. The cams 85, 86 and 87 are configured to rotate synchronously.

Next, with reference to FIG. 11, a description is given of the case where the leading edge of the printing paper P1 or P2 being printed by the print head H passes through between the pair of conveyance rollers 43. When the cams 85, 86 and 87 are clockwise rotated by 90 degrees, the cam follower 55a is lifted by the rotation of the cam 85, whereby the roller bracket 55 pivotally counterclockwise moves about the pivot shaft 55b to disengage the upper conveyance roller 43 from the lower one. Concurrently, the cam follower 57a is moved downstream by the rotation of the cam 87, whereby the roller bracket 57 is pivotally moved clockwise about the pivot shaft 57b to disengage the upper downstream output roller 46 from the lower one. Upon rotation of the cam 86 at this time, the upper upstream output roller 45 is not yet disengaged from the lower one.

Thus, the leading edge of the printing paper P1 or P2 can smoothly pass through the gap between the pair of conveyance rollers 43, which prevents the printing paper P1 or P2 from abutting on the pair of conveyance rollers 43 and thereby causing vibrations. Furthermore, since the pair of downstream output rollers 46 are disengaged from each other, dry air in the drying chamber 71 is blown through the gap between the pair of downstream output rollers 46 and then through the output port 47 in the housing 6 out of the housing 6.

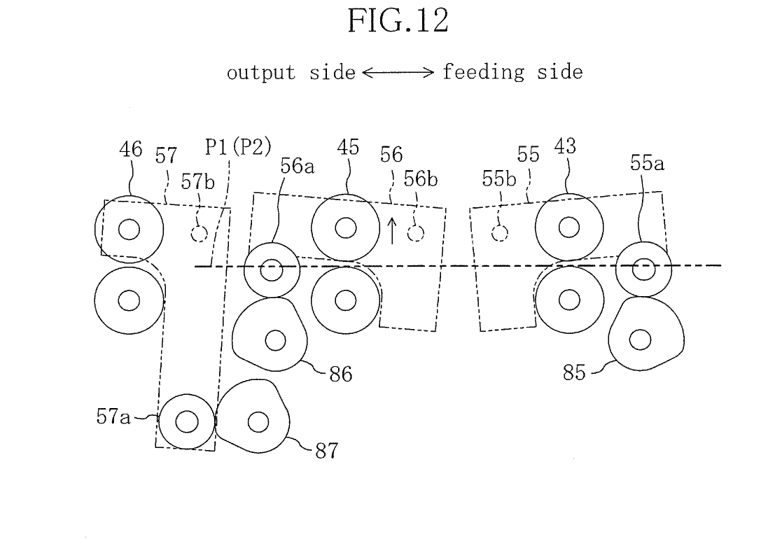

Next, with reference to FIG. 12, a description is given of the case where the image size to be printed on a single paper sheet P1 or a paper web P2 is so long that the leading edge of the printing paper P1 or P2 being printed by the print head H reaches the pair of upstream output rollers 45. When the cams 85, 86 and 87 are further clockwise rotated 90 degrees from their positions shown in FIG. 11, the cam follower 56a is lifted by the rotation of the cam 86, whereby the roller bracket 56 pivotally clockwise moves about the pivot shaft 56b to disengage the upper upstream output roller 45 from the lower one. Upon rotation of the cams 85 and 87 at this time, the upper conveyance roller 43 and the upper downstream output roller 46 remain disengaged from their respective lower ones.

Thus, the leading edge of the printing paper P1 or P2 can smoothly pass through the gap between the pair of upstream output rollers 45, which prevents the printing paper P1 or P2 from abutting on the pair of upstream output rollers 45 and thereby causing vibrations. Furthermore, since the pair of downstream output rollers 46 are disengaged from each other prior to the disengagement between the pair of upstream output rollers 45, dry air in the drying chamber 71 has been blown through the gap between the pair of downstream output rollers 46 and then through the output port 47 in the housing 6 out of the housing 6. Therefore, the amount of dry air residing in the drying chamber 71 has been reduced, which restrains the amount of dry air flowing upstream through the gap between the pair of upstream output rollers 45 upon disengagement between them. Since, thus, the disengagement between the pair of upstream output rollers 45 is carried out after the disengagement between the pair of downstream output rollers 46, this restrains heat energy from being transmitted to the elements, such as the back printing unit 4, upstream of the drying unit U6 while preventing that the leading edge of the printing paper P1 or P2 being printed by the print head H abuts on the pair of upstream output rollers 45 and thereby causes vibrations.

Although this embodiment describes the arrangement of the cams 85 and 87 configured to synchronize the disengagement between the pair of conveyance rollers 43 with that between the pair of downstream output rollers 46, the present invention is not limited to this cam configuration. For example, the pair of downstream output rollers 46 may be disengaged from each other at a desired timing by changing the initial angular position or shape of the cam 87 for the pair of downstream output rollers 46.

Although in this embodiment each downstream output roller 46 is composed of a roller shaft 46a and a roller body 46b disposed concentrically around the roller shaft 46a and having a length corresponding to the width of the printing paper P1 or P2, it is not limited to this structure. For example, the downstream output roller 46 may be composed of a roller shaft 46a and a plurality of roller bodies 46b, 46b, . . . disposed around the roller shaft 46a at spaced intervals in the axial direction of the roller shaft 46a.

### —Ink Supply System—

As shown in FIG. 5, the ink supply system for the inkjet printer A is configured to deliver ink in the ink cartridges 62 of the ink storages 3 disposed on both lateral sides of the inkjet printer A via solenoid valves 50 and delivery tubes 51 to the sub-tanks 52 and supply the ink in the sub-tanks 52 via flexible tubes 53 to the print head H.

The ink is delivered from the ink cartridges 62 to the sub-tanks 52 by pressurized air supplied into the ink cartridges 62 by a pressure pump (not shown), and then flows from the sub-tanks 52 to the print head H by negative pressure produced in pressure chambers upon ink ejection through the nozzles of the print head H.

Each sub-tank 52 is formed in the shape of a bag using a flexible material such as a resin sheet. The number of sub-tanks 52 is seven to correspond to the number of ink types having different hues. The seven sub-tanks 52 are disposed at an appropriate height in relation to the print head H so that the ink can be supplied at an appropriate pressure to the print head H.

As described above, the ink in the ink cartridges 62 is once stored in the sub-tanks 52 and then supplied from the sub-tanks 52 to the print head H. Therefore, the ink cartridges 62 can be replaced without interruption of printing. Furthermore, since the sub-tanks 52 serve also as pressure dampers, this prevents that pressure variations caused in the ink cartridges 62 are directly transmitted to the print head H and in turn prevents that an excessive pressure acts on the print head H to cause problems, such as ink leakage.

As described so far, in the inkjet printer A according to the embodiment of the present invention, the pair of upstream output rollers 45 are disengaged from each other after the disengagement between the pair of downstream output rollers 46. Therefore, after dry air blown from the dryer 72 against the printed printing paper P1 or P2 and downstream in the direction of paper conveyance passes through the gap between the pair of downstream output rollers 46 disengaged from each other and blows through the output port 47 in the housing 6 out of the housing 6, the pair of upstream output rollers 45 are disengaged from each other. Thus, the amount of dry air residing in the drying chamber 71 is reduced, which restrains the amount of dry air flowing upstream through the gap between the pair of upstream output rollers 45 upon disengagement between them. This restrains heat energy from being transmitted upstream of the drying unit U6 while preventing that the leading edge of the printing paper P1 or P2 being printed by the print head H abuts on the pair of upstream output rollers 45 and thereby causes vibrations.

As seen from the above description, the present invention has the following highly practical effect: to provide an inkjet printer that prevents the leading edge of paper being printed by the print head from abutting on rollers downstream of the print head and thereby causing vibrations while restraining heat energy from being transmitted upstream of a drying device for drying the paper. Therefore, the present invention is very useful and has high industrial applicability.

What is claimed is:

1. An inkjet printer for printing an image on paper by ejecting ink from a print head to the paper, the inkjet printer comprising:
a drying device for drying the paper after an image is printed thereon;
an upstream roller disposed upstream of the drying device in a direction of paper conveyance and engageable against a counter part thereof;
a downstream roller disposed downstream of the drying device in the direction of paper conveyance and engageable against a counter part thereof; and
an engagement/disengagement switching device for engaging and disengaging the upstream roller and its counter part against and from each other and engaging and disengaging the downstream roller and its counter part against and from each other, the engagement/disengagement switching device being configured to disengage the upstream roller and its counter part from each other after disengaging the downstream roller and its counter part from each other.

2. The inkjet printer of claim 1, wherein the drying device is configured to dry the printed paper by blowing dry air against the printed paper and downstream in the direction of paper conveyance.
